(19) United States
(12) Patent Application Publication
(10) Pub. No.: US 2015/0296838 A1
(43) Pub. Date: Oct. 22, 2015

(54) EXTRUDED LIGNOCELLULOSIC ANIMAL FEED PRODUCTS HAVING HIGH DIGESTIBILITY

(71) Applicant: Melior Engineering Consultants Ltd., London (GB)

(72) Inventor: Kenneth Hillel Peter Harris, Asker (NO)

(21) Appl. No.: 14/691,428

(22) Filed: Apr. 20, 2015

Related U.S. Application Data
(60) Provisional application No. 61/981,334, filed on Apr. 18, 2014.

(51) Int. Cl. A23K 1/00; A23K 1/14

(52) U.S. Cl. CPC A23K 1/003; A23K 1/14

(57) ABSTRACT

The present disclosure is directed to animal feed products and a method of producing animal feed products from lignocellulosic biomass. A lignin swellant is mixed with the lignocellulosic biomass and a grain or starch is added to the biomass mixture. The biomass mixture is introduced to an extruder and heated between about 140° C. and 250° C. The treated material is extruded from the extruder and pelletized.

### CROSS-REFERENCE TO RELATED APPLICATIONS

The present application claims benefit under 35 U.S.C. §119(e) of U.S. Provisional Application Ser. No. 61/981,334, filed Apr. 18, 2014, which is hereby expressly incorporated herein by reference in its entirety.

### FIELD OF THE DISCLOSURE

The present disclosure relates generally to animal feed products, and more particularly, but not by way of limitation, to animal feed products and methods of making animal feed products based upon grasses and agricultural by-products and hardwoods having high digestibility that can replace molasses and grain such as corn.

### BACKGROUND

The cost of traditional animal feed products such as grains, corn and corn silage has varied appreciably over the past decade due to variable harvests and pressure from the bioethanol industry that typically uses grain as its raw material of choice.

The present disclosure describes how the feed value of secondary raw materials such as corn cobs, straw, bagasse and deciduous wood can be substantially improved to provide an animal feed component, rich in digestible energy, that can replace part of the corn or grain otherwise needed to ensure optimal growth and, in the case of dairy cattle, milk yields.

Much work has been done to improve the feed value of low grade agricultural residues, in particular the use of steam treatment processes, also known as steam explosion with or without the addition of acid catalysts, and the addition of quick- or slaked lime (calcium oxide and hydroxide, respectively) to biomass. The former suffer from the disadvantages of being energy intensive, losses of the more labile sugar components as well as requiring large capital investment and a large catchment area for raw material if they are to be of a size that makes the product cost efficient, whereas the latter suffer from the hazardous nature of the highly alkaline materials needed and the necessity of very careful control if the product is to be palatable.

To this end, although animal feed products are made from biomass, a need remains for a more energy efficient method than steam processes that can be operated on a smaller scale, while not requiring the use of hazardous chemicals. It is to such a method of making animal feed products and animal feed products that the present disclosure is directed.

### SUMMARY OF THE DISCLOSURE

Animal feed products having in vitro digestibilities in excess of 60% made by heating and extruding in an extruder equipped with mixing, shearing and venting zones, a mixture of at least 30 parts by dry weight of a lignocellulosic biomass, from 0-70 parts by dry weight of a grain or starch or mixture of these with from 0% to 8% of glycerol or similar palatable substance capable of acting as a lubricant and as a swellant for lignin all of which are added before extrusion, the mixture preferably containing less than 30% moisture. The mixing and shearing zones in the extruder are heated to at least 140° C. but not more than 250° C. and the material resides therein for at least for at least 10 seconds. The lubricant and lignin swellant may also be a non-hydrocarbon oil such as a vegetable oil or a fat or a fatty acid. The form of pelletisable crumbs or granulates consisting of particles of which 90% are smaller than 0.2 mm. The biomass being extruded is such that at least 90% of the particles are smaller than 10 mm. The biomass composition to be extruded is first compacted to a bulk density of at least 250 kg/m³ and in another embodiment between 400 and 500 kg/m³.

The method is directed to making animal feed products includes providing a lignocellulosic biomass. A lignin swellant is mixed with the biomass to produce a biomass mixture. 0% to 8% of a lignin swellant is mixed with at least 30 parts of dry weight of the biomass. The lignin swellant can be glycerol, vegetable oil, fat, fatty acid, or the like. 0-70 parts by dry weight of grain or starch is added to the biomass mixture;

The mixture is provided to a conventional extruder. The mixture is heated to between about 140° C. and about 250° C. The treated material is extruded from the extruder. The material may be pelletized into pellets.

### DETAILED DESCRIPTION

Various embodiments of the present disclosure are broadly directed to making pellets suitable for animal feed made by an extrusion process containing a palatable substance capable of swelling lignin. For example, a polyhydric alcohol such as glycerol, although an oil such as a vegetable oil or fatty acid can also be used as a lignin swellant. Unexpectedly, starch-rich substances such as grain can also be employed as lignin swellants, because these break down during processing to polyhydric alcohols, e.g., glucose, which may function as lignin swellants under the conditions pertaining in a conventional extruder equipped with mixing, shearing and venting zones. However, one of ordinary skill in the art will understand that any extruder may be utilized so long as the extruder functions in accordance with the present disclosure as described herein.

In one embodiment, a biomass made from an annual crop residue, which may be in the form of pellets, or a hardwood containing less than 50% moisture, is broken down such that it can easily be accommodated in the extruder. For example, at least 90% of the biomass particles are smaller than 10 mm, or in another embodiment, smaller than 0.2 mm. The biomass is then mixed with glycerol and/or a grain such as corn, millet or wheat. For example, a mixture of at least 30 parts by dry weight of lignocellulosic biomass, between 0-70 parts by dry weight of a grain or starch or mixture of these between 0% to 8% of glycerol or similar paraltable substances capable of acting as a lubricant and as a swellant for lignin all of which are added before extrusion. The mixture contains less than 30% moisture.

The mixture is conveyed to a conventional compounding extruder, in at least one embodiment equipped with a macerating zone. The mixture is heated to at least 140° C. and in another embodiment at least 150° C., but not more than 250° C. for at least 10 seconds and in one embodiment at least 30 secs, such that the material becomes sufficiently fluid to permit it to flow easily. Any volatile substances formed during the heating process are removed through vents placed appropriately along the extruder.

Conditions are maintained in the extruder to ensure that the product leaving the extruder is in the form of pelletisable crumbs. The use of glycerol and/or grain, allows the extruder to operate without excessive adiabatic heating and thus, ensures that the product is not thermally degraded. Additionally, the extruder's content of undesirable components such as furfural is minimized. If a grain is added before extrusion, the process converts much of its starch content to glucose, which is most advantageous when it is used, e.g., in a horse or swine feed.

In another embodiment, the mixture of size reduced biomass and palatable additive is compacted in a pellet mill or other device capable of raising its bulk density to at least 250 kg/m³ and this material then used as a feed for the extruder. In another embodiment, the biomass mixture is compacted to a bulk density between about 400 kg/m³ and about 500 kg/m³. This procedure is especially beneficial when handling materials of low bulk density such as straw and bagasse that may otherwise be difficult to feed at the necessary rate to an extruder.

Products thus made will have a total digestibility as cattle feed that is very considerably greater than the materials used, from more than 60% to as much as 85% depending upon the raw materials chosen.

Prior to their use as a feed, the extruded products can advantageously be mixed with a basic substance such as calcite or lime in a quantity sufficient to bring the pH of a 10% dispersion in water up to no less than 4,5 and preferably between 5 and 6. Also the products' protein value as cattle feed can be enhanced by mixing with a low cost nitrogen source e.g., 1 part of urea to 5-8 parts of monomeric sugars contained in the treated biomass.

From the above description, it is clear that the present disclosure is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed.

What is claimed is:

1. Animal feed products having in vitro digestibilities in excess of 60% made by heating and extruding in an extruder equipped with mixing, shearing and venting zones, a mixture of at least 30 parts by dry weight of a lignocellulosic biomass, from 0-70 parts by dry weight of a grain or starch or mixture of these with from 0% to 8% of glycerol or similar palatable substance capable of acting as a lubricant and as a swellant for lignin all of which are added before extrusion, the mixture preferably containing less than 30% moisture.

2. The products in accordance with claim 1 wherein the mixing and shearing zones in the extruder are heated to at least 140° C. but not more than 250° C. and the material resides therein for at least for at least 10 seconds.

3. The products in accordance with claim 1 wherein the lubricant and lignin swellant may also be a non-hydrocarbon oil such as a vegetable oil or a fat or a fatty acid.

4. The products in accordance with claim 1 having the form of pelletisable crumbs or granulates consisting of particles of which 90% are smaller than 0.2 mm in size.

5. The products in accordance with claim 1, where the biomass being extruded is such that at least 90% of the particles are smaller than 10 mm.

6. The products in accordance with claim 1, where the biomass composition to be extruded is first compacted to a bulk density of at least 250 kg/m³ and preferably between 400 and 500 kg/m³.

7. A method for making animal feed products, comprising the steps of:
providing a lignocellulosic biomass having portions smaller than 10 mm;
mixing 0% to 8% of a lignin swellant with at least 30 parts of dry weight of the biomass;
adding 0-70 parts by dry weight of grain or starch to form a biomass mixture;
introducing the biomass mixture into an extruder;
heating the biomass mixture between about 140° C. to about 250° C.; and
extruding a treated material from the extruder.

8. The method claim 7 wherein the lignin swellant is glycerol.

9. The method of claim 7 wherein the lignin swellant is a vegetable oil, a fat or a fatty acid.

10. The method of claim 7 wherein the biomass mixture has less than 30% moisture.

11. The method of claim 7 wherein 90% of the lignocellulosic biomass is less than 10 mm in size.

12. The method of claim 7 wherein the treated material to be extruded is compacted to a bulk density of at least 250 kg/m³.

13. The method of claim 7 wherein the treated material to be extruded is compacted to a bulk density of between about 400 kg/m³ and about 500 kg/m³.

14. The method of claim 7 further comprising the step of:
maintaining the biomass mixture in the extruder for at least 10 seconds.

15. The method of claim 7 further comprising the step of:
pelletizing the extruded treated material to pellets.

16. The method of claim 7 wherein the biomass is from an annual crop residue.

17. The method of claim 7 wherein the biomass is from a hardwood containing less than 50% moisture.

18. The method of claim 7 wherein the extruder is provided with a mixing, shearing and venting zone.

19. The method of claim 7 further comprising the step of:
mixing the extruded treated material with a basic substance in a quantity sufficient to bring the pH of a 10% dispersion in water up to no less than 4.5.

20. The method of claim 7 further comprising the step of:
mixing the extruded treated material with one part urea to 5-8 parts monomeric sugars.
